(19) United States
(12) Patent Application Publication
(10) Pub. No.: US 2026/0133024 A1
(43) Pub. Date: May 14, 2026

(54) SCALE ELEMENT FOR AN INDUCTIVE ANGLE MEASURING DEVICE

(71) Applicant: DR. JOHANNES HEIDENHAIN GmbH, Traunreut (DE)

(72) Inventors: Martin HEUMANN, Traunstein (DE); Christoph HEINEMANN, Übersee (DE)

(21) Appl. No.: 19/379,167

(22) Filed: Nov. 4, 2025

(30) Foreign Application Priority Data
Nov. 11, 2024 (EP) 24211950.1

(51) Int. Cl. G01B 7/30; G01D 5/20

(52) U.S. Cl. CPC G01B 7/30; G01D 5/20

(57) ABSTRACT

A scale element for an inductive angle measuring device includes a substrate on which a graduation track is arranged. The graduation track is formed along a circumferential direction from a periodic sequence of alternately arranged electrically conductive graduation regions and non-conductive graduation regions. The electrically conductive graduation regions are formed from a layer of electrically conductive material. At least one bore is arranged in the substrate. The conductive graduation regions each have an opening, in which the electrically conductive material encloses the opening. In at least one of the electrically conductive graduation regions, the bore is arranged in the substrate (2.1) through the opening. In addition, two electrically conductive graduation regions adjacent in the circumferential direction are arranged such that, along the radial direction, angular distances differ in size between their conductive layers.

### CROSS-REFERENCE TO RELATED APPLICATIONS

The present application claims priority to Application No. 24211950.1, filed in the European Patent Office on Nov. 11, 2024, which is expressly incorporated herein in its entirety by reference thereto.

### FIELD OF THE INVENTION

The present invention relates to a scale element for an inductive angle measuring device, e.g., for determining an angular position of the scale element relative to a sensing element.

### BACKGROUND INFORMATION

Inductive angle measuring devices are used, for example, to determine an angular position of machine parts that are rotatable relative to each other. In inductive angle measuring devices, excitation tracks and receiving tracks, for example, in the form of conductive paths, are often applied to a common, usually multilayer circuit board, which is firmly connected, for example, to a stator of the angle measuring device. Opposite this printed circuit board is a scale element on which graduation structures are applied and which is firmly connected to a movable part of the angle measuring device. When a time-varying electrical excitation current is applied to the excitation tracks, signals dependent on the position are generated in the receiving tracks during the relative movement between the scale element and the sensing element. These signals are further processed in an evaluation electronic system.

A scale element for an inductive angle measuring device is described in European Patent Document No. 4 421 454 and U.S. Pat. No. 12,449,247. The scale element described therein includes two graduation tracks, respectively consisting of a periodic sequence of alternately arranged electrically conductive graduation regions and non-conductive graduation regions. The scale element is fastened with the aid of screws in fastening bores, all of which are arranged within electrically conductive graduation structures.

### SUMMARY

Example embodiments of the present invention provide a compact and cost-effective scale element that offers flexible fastening options and yet can be used for a comparatively accurate inductive angle measuring device.

The scale element, which is suitable and intended for an inductive angle measuring device, includes a substrate on which a graduation track is arranged. The graduation track is formed along a measuring direction from a periodic sequence of alternately arranged electrically conductive graduation regions and comparatively non-conductive graduation regions, in which the electrically conductive graduation regions are respectively formed from a layer of electrically conductive material. The layer or layer surface of electrically conductive material extends along the circumferential direction, on the one hand, and along the radial direction, on the other hand. Furthermore, at least one bore is arranged and provided in the substrate, which bore is configured for fastening the scale element to a machine part. At least one electrically conductive graduation region has an opening, and the electrically conductive material encloses the opening. In addition, in at least one of the electrically conductive graduation regions, the at least one bore is arranged in the substrate through the opening. Two electrically conductive graduation regions adjacent in the circumferential direction are arranged such that the angular distances in the circumferential direction between the conductive layers of the electrically conductive graduation regions differ in size along the radial direction.

Accordingly, adjacent electrically conductive graduation regions have different angular distances (in the circumferential direction) at different distances from the axis. In other words, if a first distance is measured radially inwards between two points lying opposite each other in the circumferential direction on the respective contour of an electrically conductive graduation region, a second distance differs in size compared to the first distance at a point offset radially thereto. Points lying opposite each other are located, for example, on one and the same virtual circle line whose center point is located on the axis. The contours of the electrically conductive graduation regions or electrically conductive layers in question thus do not extend straight in a radial direction over their entire radial extension. Angular distances between two electrically conductive graduation regions adjacent in the circumferential direction refer to a respective center angle around the axis and are specified in degrees.

For example, there is a first distance between two electrically conductive graduation regions that are adjacent in the circumferential direction, and a second distance radially offset thereto. The first distance and the second distance can be greater than a third distance located radially between the first distance and the second distance.

The electrically conductive graduation regions are thus formed from a layer of electrically conductive material. The comparatively non-conductive graduation regions may be made of plastic (e.g., printed circuit board material). The scale element may, for example, have a plastic printed circuit board material as a substrate. Alternatively, the substrate may be formed from a layered body that includes a relatively thick steel layer and a non-conductive layer (e.g., plastic layer), in which the steel layer is arranged on the side of the scale element facing away from the graduation regions. Comparatively non-conductive refers, for example, to the ratio of the electrical conductivities of the materials of the alternately arranged graduation regions. For example, this ratio may be greater than 10 or greater than 50. The layer of electrically conductive material of the electrically conductive graduation regions is, for example, larger than 12 μm or 0.012 mm. On the other hand, it is considered advantageous, for example, for economic reasons, if the layer is thinner than 1 mm, e.g., thinner than 0.5 mm, thinner than 0.1 mm, etc.

A bore should be understood to mean a hole that does not necessarily have to be round. For example, the bore may also be angular or elliptical in shape and produced by a punching or milling process, for example.

The scale element is used in an angle measuring device to determine an angular position relative to a sensing element. The scale element is arranged rotatably about an axis relative to the sensing element, so that the measuring direction represents the circumferential direction in relation to the axis.

For example, a further bore is also arranged in a non-conductive graduation region in the substrate.

For example, the graduation track has n electrically conductive graduation regions, and m bores are arranged in the substrate, with n #m. For example, the scale element may be arranged such that the relationship n<m is satisfied.

For example, n may be an odd number, and m may be an even number.

According to example embodiments, at least one electrically conductive graduation region is bounded in the circumferential direction by a convex contour. This means that electrically conductive graduation regions opposite each other in the circumferential direction are bounded by a convex contour in the opposite sections. For example, this contour may be round and a circular line section. In contrast to electrically conductive graduation regions in conventional inductive scale elements, there is no continuous straight contour extending in a radial direction. As an alternative to the round contour mentioned, a polygon-like contour may also be provided, e.g., in the form of a half hexagon. The contour may also be concave.

For example, the graduation track is formed in the shape of a ring or a circular ring, in which, for example, the center point of the ring-shaped graduation track is located on the axis.

The scale element may be configured such that it has one opening in each one of multiple electrically conductive graduation regions and/or that at least one electrically conductive graduation region has multiple openings. For example, all electrically conductive graduation regions of the scale element may have multiple openings.

For example, all electrically conductive graduation regions are geometrically identical.

According to example embodiments, at least part of the openings in the electrically conductive graduation regions are geometrically identical.

For example, the graduation track extends along a graduation circle line with the center point, which, for example, is located on the axis, and the openings are arranged such that they have the same distance from the center point and are arranged equidistantly along the graduation circle line.

For example, the scale element includes multiple electrically conductive graduation regions having bores. The bores are arranged so that they have the same distance from the center point and are arranged equidistantly along the graduation circle line.

The distances between the openings or between the bores are specified in degrees and refer to a respective center angle around the axis or around the center point of the graduation circle line.

According to example embodiments, the scale element includes at least one fastener device arranged in the bore. The fastener device may be arranged flush or recessed with respect to the electrically conductive graduation regions in relation to the axial direction and, in any case, does not project beyond the surface of the electrically conductive graduation regions in the axial direction. An axial direction refers to a direction that is oriented parallel to the axis.

For example, the fastener device is produced from electrically conductive material and may be arranged as a screw. Alternatively, a rivet, a metal pin, a dowel pin, etc., may be provided as a fastener device, and the scale element may additionally be glued to the machine part to which it is fastened. For example, the fastener device may be used to produce a form lock, which is important for a functionally safe arrangement. At the same time, the fastener device may be used to center the scale element. For example, a configuration is also possible in which centering lugs or centering blades are pressed into the bores and the scale element is additionally fixed with an adhesive connection.

For example, the scale element includes a plurality of fastener devices, and the scale element includes a plurality of the electrically conductive graduation regions, which have bores, in which the fastener devices are arranged.

According to example embodiments, the graduation track has n electrically conductive graduation regions, and the scale element includes p fastener devices arranged in the bores. The following condition is satisfied: n #p. For example, the following relationship is satisfied: n<p, in which it may be provided that n is an odd number and p is an even number.

According to example embodiments, an inductive angle measuring device includes the scale element and a sensing element.

Further features and aspects of example embodiments of the present invention are described in more detail below with reference to the appended schematic Figures.

### BRIEF DESCRIPTION OF THE DRAWINGS

FIG. 1 is a top view of one side of a scale element.

FIG. 2 is a perspective cross-sectional view of the scale element.

FIG. 3 is a cross-sectional view through a bore of the scale element.

FIG. 4 is a top view of one side of the sensing element.

### DETAILED DESCRIPTION

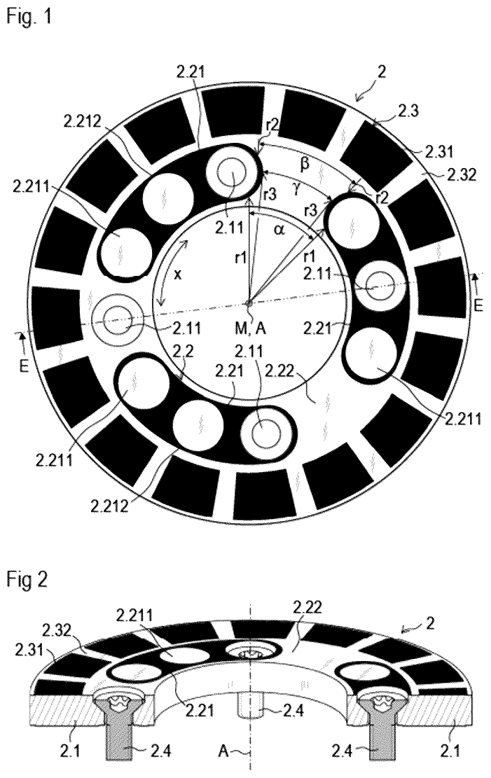

An angle measuring device includes a scale element 2 (see, e.g., FIGS. 1, 2 and 3) and a sensing element 1 (see, e.g., FIG. 4), which may be used to acquire an angular position of the scale element 2. The scale element 2 is arranged rotatably around an axis A relative to the sensing element 1. Such an angle measuring device may be used, for example, in a drive device, such as a robot, in which the scale element 2 is rotationally fixed to a drive shaft of a motor, for example.

The sensing element 1 illustrated in FIG. 4 is used to sense the scale element 2 and is arranged as a printed circuit board with multiple layers and electronic components. In the illustrated example embodiment, the electronic components are only mounted on one side of the printed circuit board, namely, on the side facing away from the scale element 2, and are thus not visible in the view of FIG. 4. Alternatively or additionally, it would also be possible to provide both sides of the printed circuit board with electronic components.

The sensing element 1 has a first receiving track 1.1 and a second receiving track 1.2 for determining the angle information. The receiving tracks 1.1, 1.2 each have a ring shape, in which, for both receiving tracks 1.1, 1.2, their center M is located on the axis A. Accordingly, the receiving tracks 1.1, 1.2 are arranged concentrically in a first approximation with respect to the center point M.

In the illustrated example embodiment, the first receiving track 1.1 include four receiving conductive paths 1.11. The receiving conductive paths 1.11 of the first receiving track 1.1 are arranged offset in relation to each other in the circumferential direction x and have a spatially periodic path that is substantially sine-shaped or sinusoidal.

In the illustrated example embodiment, the second receiving track 1.2 includes eight receiving conductive paths 1.21, which are arranged offset relative to each other in the circumferential direction x.

Furthermore, the sensing element 1 includes a first excitation track 1.3 and a second excitation track 1.4. In the illustrated example embodiment, the excitation tracks 1.3, 1.4 include multiple excitation lines, but each may also be formed as only one excitation line. The first receiving track 1.1 is located radially inside the first excitation track 1.3 and radially outside the second excitation track 1.4. The second excitation track 1.4 is also located radially outside the second receiving track 1.2. Both the excitation tracks 1.3, 1.4 and the receiving tracks 1.1, 1.2 extend along the circumferential direction x.

The receiving conductive paths 1.11 of the first receiving track 1.1, as well as the receiving conductive paths 1.21 of the second receiving track 1.2, are connected with vias in different layers of the printed circuit board, so that unwanted short circuits are avoided at crossing points. Although, strictly speaking, each of the receiving conductive paths 1.11, 1.21 consists of, or includes, many conducting pieces, each of which is distributed and connected together on two planes or layers, such a structure is collectively referred to as a receiving conductive path 1.11, 1.21.

In FIG. 1, the scale element 2 is illustrated in a top view, in which the scale element 2 of FIG. 1 is illustrated enlarged in comparison to the sensing element 1 of FIG. 4. The scale element 2 has an annular or circular shape. The scale element 2 includes a substrate 2.1 (see, e.g., FIG. 2) on which two graduation tracks 2.2, 2.3 are arranged. In the illustrated example embodiment, the substrate 2.1 is produced from printed circuit board material including plastic, e.g., epoxy resin. The graduation tracks 2.2, 2.3 are annular and are arranged concentrically with respect to the axis A with different radii on the substrate 2.1. The graduation tracks 2.2, 2.3 include graduation structures having a periodic sequence of electrically conductive graduation regions 2.21, 2.31 and non-conductive graduation regions 2.22, 2.32 arranged alternately along the circumferential direction x, in which the electrically conductive graduation regions 2.21, 2.31 are each formed from a layer of electrically conductive material. The thickness of this layer is 18 μm. In the illustrated example embodiment, copper is applied to the substrate 2.1 as the material for the electrically conductive graduation regions 2.21, 2.31. In the non-conductive graduation regions 2.22, 2.32, on the other hand, the substrate 2.1 is not coated. With the configuration having two graduation tracks 2.2, 2.3, the angular position of the scale element 2 can be determined absolutely. The second (outer) graduation track 2.3 of the scale element 2 has the greater number of graduation regions 2.31, 2.32 along the circumferential direction x, so that through these the greater resolution with respect to the measurement of the angular position can be achieved.

The electrically conductive graduation regions 2.21 of the first (inner) graduation track 2.2 have openings 2.211, so that the layer of electrically conductive material is open at these points, or the substrate 2.1 is not coated in these regions. In the illustrated example embodiment, the openings 2.211 have a circular geometry. The openings 2.211 are arranged so that they each have the same distance to the center point M. For example, the centers of gravity or the centers of the openings 2.211 are arranged at the same distance from the center point M.

The electrically conductive graduation regions 2.21 are configured or arranged such that each opening 2.211 is enclosed by the electrically conductive graduation region 2.21, so that there are webs 2.212 of electrically conductive material on both sides around the opening 2.211 and there is a closed contour of electrically conductive material around the opening 2.211. Two electrically conductive graduation regions 2.21 adjacent in the circumferential direction x are configured such that angular first, second and third distances α, β, γ differ in size in the circumferential direction x between their conductive layers along the radial direction. Thus, for example, the first angular distance α is located at a first distance from axis A (radial distance) and the second angular distance B is located at a second radial distance r2. The following relationship is satisfied:

$$r 1 \neq r 2 and α \neq β .$$

For example, the third distance γ, which is located in the radial center of the first graduation track 2.2 at a third radial distance r3, is smaller than the first distance α, which is located radially further inwardly, and also smaller than the second distance β, which is located radially outwardly relative to the third distance γ. Accordingly, the first distance α and the second distance β are greater than the third distance γ arranged radially between the first and the second distance α, β. Thus, the angular distances α, β, γ in the circumferential direction x differ in size depending on the radial position or radial distance r1, r2, r3.

In the illustrated example embodiment, the electrically conductive graduation regions 2.21 each have a shape that is bounded by a round contour in the circumferential direction x, and the electrically conductive graduation regions 2.21 have a convex contour in these regions.

In each of the electrically conductive graduation regions 2.21, bores 2.11 are arranged through an opening 2.211 in the substrate 2.1. The bores 2.11 are thus arranged along the first (inner) graduation track 2.2 in the substrate 2.1. In the illustrated example embodiment, four bores 2.11 are provided, which each have the same distance from the center point M and are arranged along the circumferential direction x (e.g., a distance of 90°). As illustrated in FIG. 1, three bores 2.11 are within electrically conductive graduation regions 2.21, and one bore 2.11 is within a non-conductive graduation region 2.22.

In the illustrated example embodiment, the first graduation track 2.2 has three electrically conductive graduation regions 2.21 (n=3). The scale element 2 includes four bores 2.11 in the substrate 2.1 for fastening the scale element to a machine part (m=4). Accordingly, the number n of electrically conductive graduation regions 2.21 differs from the number m of bores 2.11 (n #m). For example, the number n of electrically conductive graduation regions 2.21 is smaller than the number m of bores 2.11 in the substrate 2.1 (n<m). In the illustrated example embodiment, the number n of electrically conductive graduation regions 2.21 corresponds to an odd number and the number m of bores 2.11 corresponds to an even number.

FIG. 2 is a perspective cross-sectional view taken along a line E-E (see, e.g., FIG. 1) through the scale element 2, in which fastener devices 2.4, e.g., screws, inserted into the bores 2.11 are also illustrated. As described above, the graduation track 2.2 has a total of three electrically conductive graduation regions 2.21 (n=3). In addition, the scale element 2 includes four fastener devices 2.4 (p=4). Accordingly, the number n of electrically conductive graduation regions 2.21 differs from the number p of fastener devices 2.4 (n #p). For example, the number n of electrically conductive graduation regions 2.21 is smaller than the number p of fastener devices 2.4 (n<p). In the illustrated example embodiment, the number n of electrically conductive graduation regions 2.21 corresponds to an odd number and the number p of bores 2.11 corresponds to an even number.

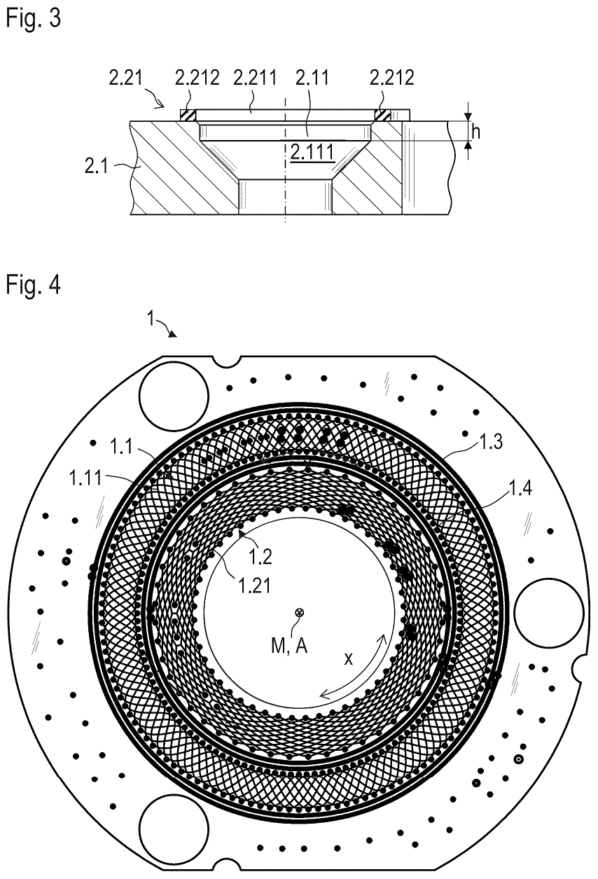

FIG. 3 is an enlarged cross-sectional view through a part of the scale element 2 in the region of the first graduation track 2.2. As illustrated in FIG. 3, the thickness of the layer of electrically conductive material of the electrically conductive graduation region 2.21 is shown exaggeratedly large for illustration purposes. The bore 2.11 is arranged as a stepped through bore. For example, the bore 2.11 has a conical region 2.111, which is produced, e.g., by countersinking. The conical region 2.111 is arranged recessed by a dimension h with respect to the surface of the substrate 2.1 or in the axial direction. As a result, a fastener device 2.4, e.g., arranged as a countersunk screw head, may be arranged in the bore 2.11, and the fastener device 2.4 is recessed with respect to the surface of the substrate 2.1 and with respect to the surface of the electrically conductive graduation region 2.21. The fastener device 2.4 is used to fasten the scale element 2 to a machine part and, for example, is made of steel and is therefore electrically conductive.

In the assembled state, the sensing element 1 and the scale element 2 are opposite each other with an axial distance or an air gap, so that when there is a relative rotation between the scale element 2 and the sensing element 1 a signal depending on the respective angular position may be generated in each of the receiving conductive paths 1.11, 1.21 by induction effects. A prerequisite for the formation of corresponding signals is that the excitation tracks 1.3, 1.4 generate a time-varying electromagnetic excitation field in the region of the respective sensed graduation structures. In the illustrated example embodiment, the excitation tracks 1.3, 1.4 are arranged as multiple planar-parallel current-carrying individual conductive paths.

If the excitation tracks 1.3, 1.4 are supplied with current, a tubularly or cylindrically oriented electromagnetic field is formed around the excitation tracks 1.3, 1.4. The field lines of the resulting electromagnetic field extend around the excitation tracks 1.3, 1.4, and the direction of the field lines depends on the direction of the current in the excitation tracks 1.3, 1.4. Eddy currents are induced in the region of the electrically conductive graduation regions 2.21, 2.31, so that a modulation of the field is achieved that is dependent on the angular position. Accordingly, through the receiving tracks 1.1, 1.2, the relative angular position may be measured.

The sensing element 1 has an electronic circuit with electronic components that are electrically connected to each other. The electronic circuit may include an ASIC component. The signals generated by the receiving tracks 1.1, 1.2 are further processed via some of the electronic components that form an evaluation circuit. For example, in the illustrated configuration with the two graduation tracks 2.1, 2.2 and the two receiving tracks 1.1, 1.2, an absolute position may be calculated by an evaluation ASIC. The electronic circuit of the sensing element 1 operates not only as an evaluation device, but also as an excitation control device under whose control the excitation current is generated or produced, which flows through the excitation tracks 1.3, 1.4. Thus, the excitation tracks 1.3, 1.4 are supplied with current by one and the same excitation control device.

The first receiving track 1.1 is surrounded radially on the outside by the first excitation track 1.3 and at the same time surrounded radially on the inside by the second excitation track 1.4. In contrast, the second receiving track 1.2 is only surrounded on one side by the second excitation track 1.4. By the one-sided application of the excitation field with respect to the second receiving track 1.2, an extremely space-saving configuration of the sensing element 1 can be achieved.

The configuration of the first electrically conductive graduation regions 2.21, e.g., the positioning and dimensioning of the openings 2.211, ensures a suitable formation of the eddy currents, which can flow around the opening 2.211 over 360°, e.g., in the webs 2.212 made of electrically conductive material.

In conventional configurations of electrically conductive graduation regions, two electrically conductive graduation regions adjacent in the circumferential direction x are arranged such that angular distances between their conductive layers are equal in size along the radial direction. This is the case because, for example, the electrically conductive graduation regions 2.21 are bounded in the circumferential direction x by one contour that extends in a straight line in the radial direction.

Improved signal quality, and, thus, improved measurement accuracy can be achieved by utilizing the scale element 2 with bores 2.11 and electrically conductive graduation regions 2.21 as described herein.

What is claimed is:

1. A scale element for an inductive angle measurement device, comprising:
a substrate including at least one bore configured for fastening the scale element to a machine part; and
a graduation track arranged on the substrate along a circumferential direction, the graduation track including a periodic sequence of alternately arranged electrically conductive graduation regions and non-conductive graduation regions, each electrically conductive graduation regions being formed of a layer of electrically conductive material that extends along the circumferential direction and a radial direction;
wherein at least one of the electrically conductive graduation regions includes an opening that is enclosed by the electrically conductive material, the bore in the substrate being arranged through the opening; and
wherein the conductive layers of two circumferentially adjacent electrically conductive graduation regions have angular spacing that vary in size along the radial direction.

2. The scale element according to claim 1, wherein a further bore is arranged in the substrate in corresponding non-conductive graduation region.

3. The scale element according to claim 1, wherein the graduation track includes n electrically conductive graduation regions and m bores are arranged in the substrate, in which n≠m.

4. The scale element according to claim 3, wherein n<m.

5. The scale element according to claim 3, wherein n is an odd number, and m is an even number.

6. The scale element according to claim 1, wherein a first distance between the two adjacent electrically conductive graduation regions and a second distance between the two adjacent electrically conductive graduation regions are greater than a third distance of the two adjacent electrically conductive graduation regions located radially between the first distance and the second distance.

7. The scale element according to claim 1, wherein at least one of the electrically conductive graduation regions is bounded in the circumferential direction by a convex contour.

8. The scale element according to claim 1, wherein at least one of the electrically conductive graduation regions is bounded in the circumferential direction by a round contour.

9. The scale element according to claim 1, wherein the graduation track includes n electrically conductive graduation regions, and the scale element includes p fastener devices arranged in the bores, in which n #p.

10. The scale element according to claim 9, wherein n<p.

11. The scale element according to claim 9, wherein n is an odd number, and p is an even number.

12. The scale element according to claim 10, wherein n is an odd number, and p is an even number.

13. The scale element according to claim 1, wherein the bore is arranged as a countersunk bore that is recessed with respect to a surface of the substrate and with respect to a surface of the electrically conductive graduation region.

14. The scale element according to claim 2, wherein the further bore is arranged as a countersunk bore that is recessed with respect to a surface of the substrate and with respect to a surface of the electrically non-conductive graduation region.

15. The scale element according to claim 1, wherein each electrically conductive graduation region is bounded in the circumferential direction by a convex contour.

16. The scale element according to claim 1, wherein each electrically conductive graduation region is bounded in the circumferential direction by a round contour.

17. The scale element according to claim 1, wherein all of the electrically conductive graduation regions are identical.

18. The scale element according to claim 1, wherein the at least one of the electrically conductive graduation regions (2.21) that includes an opening includes a plurality of the electrically conductive graduation regions.

19. An inductive angle measurement device, comprising:
a scale element as recited in claim 1; and
a sensing element including receiving tracks, the scale element and the sensing element being spaced from each other along an axial direction and being rotatable relative to each about an axis.

20. The inductive angle measurement device according to claim 19, wherein the receiving tracks are arranged concentrically with respect to a common center that is located on the axis.
